(19) United States
(12) Patent Application Publication
(10) Pub. No.: US 2007/0012846 A1
(43) Pub. Date: Jan. 18, 2007

(54) Container and holder for the container

(76) Inventor: Ning Wan, Geneva (CH)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/183,354

(22) Filed: Jul. 18, 2005

(51) Int. Cl. F16B 1/00

(52) U.S. Cl. 248/316.1; 248/229.16; 248/905

(57) ABSTRACT

A container and a holder for such a container is provided. More particularly, a container that comprises an attachment element capable of attaching the container to a holder for the container is provided.

### FIELD OF THE INVENTION

The present invention relates to a container and a holder for such a container. More particularly, the present invention relates to a container that comprises an attachment element capable of attaching the container to a holder for the container.

### BACKGROUND OF THE INVENTION

Containers and holders for containers are known in the art. For example, containers have been designed with edges that slide freely into receiving slots on corresponding holders. In other examples, holders have been designed with fingers that flex to receive containers.

However, none of the prior art containers comprise at least one surface that comprises an attaching element that is capable of releasably attaching the container to its corresponding holder.

Accordingly, there is a need for a container that comprises an attachment element capable of attaching the container to a holder for the container; a container product comprising such a container housing a fibrous structure; a container system comprising such a container and a holder for the container; and a kit comprising such a container and a holder for the container.

### SUMMARY OF THE INVENTION

The present invention fulfills the needs described above by providing a container comprising an attachment element capable of attaching the container to a holder for the container, and a holder for the container.

In one example of the present invention, a container comprising a surface having an attachment element capable of attaching the container to a holder for the container is provided.

In another example of the present invention, a container product comprising a container according to the present invention wherein a fibrous structure is housed within the container is provided.

In even another example of the present invention, a holder for a container, the holder comprising an receiving element capable of receiving a container is provided.

In yet another example of the present invention, a container system comprising:

a. a container comprising a surface having an attachment element capable of attaching the container to a holder for the container; and

b. a holder for the container;

wherein the container is releasably attached to the holder by the attachment element is provided.

In even another example of the present invention, a kit comprising:

a. a container comprising a surface having an attachment element capable of attaching the container to a holder for the container; and

b. a holder for the container; and

c. optionally, a fibrous product, such as a wet wipe,

wherein the container and holder and optionally, the fibrous product, are packaged together is provided.

Accordingly, the present invention provides a container, a holder for a container, a container product comprising a fibrous structure, a container system, and a kit comprising a container and a holder.

### BRIEF DESCRIPTION OF THE DRAWINGS

FIG. 1 is a schematic representation of a container system in accordance with the present invention;

FIG. 2 is a schematic representation of a container in accordance with the present invention;

FIG. 3 is a schematic representation of a container in accordance with the present invention;

FIG. 4 is a schematic representation of a container in accordance with the present invention;

FIG. 5 is an enlarged schematic representation of a portion of the container of FIG. 4;

FIG. 6 is a schematic representation of a container in accordance with the present invention;

FIG. 7 is a schematic representation of a holder in accordance with the present invention;

FIG. 8 is a schematic representation of a holder in accordance with the present invention;

FIG. 9 is a schematic representation of a holder in accordance with the present invention;

FIG. 10 is a schematic representation of a container in accordance with the present invention.

### DETAILED DESCRIPTION OF THE INVENTION

“Fiber” as used herein means an elongate physical structure having an apparent length greatly exceeding its apparent diameter, i.e. a length to diameter ratio of at least about 10. Fibers having a non-circular cross-section and/or tubular shape are common; the “diameter” in this case may be considered to be the diameter of a circle having cross-sectional area equal to the cross-sectional area of the fiber. More specifically, as used herein, “fiber” refers to fibrous structure-making fibers. The present invention contemplates the use of a variety of fibrous structure-making fibers, such as, for example, natural fibers or synthetic fibers, or any other suitable fibers, and any combination thereof.

Natural fibrous structure-making fibers useful in the present invention include animal fibers, mineral fibers, other plant fibers and mixtures thereof. Animal fibers may, for example, be selected from the group consisting of: wool, silk and mixtures thereof. The other plant fibers may, for example, be derived from a plant selected from the group consisting of: wood, cotton, cotton linters, flax, sisal, abaca, hemp, hesperaloe, jute, bamboo, bagasse, kudzu, corn, sorghum, gourd, agave, loofah and mixtures thereof.

Wood fibers; often referred to as wood pulps include chemical pulps, such as kraft (sulfate) and sulfite pulps, as well as mechanical and semi-chemical pulps including, for example, groundwood, thermomechanical pulp, chemi-mechanical pulp (CMP), chemi-thermomechanical pulp (CTMP), neutral semi-chemical sulfite pulp (NSCS). Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified and/or layered web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

The wood pulp fibers may be short (typical of hardwood fibers) or long (typical of softwood fibers). Nonlimiting examples of short fibers include fibers derived from a fiber source selected from the group consisting of Acacia, Eucalyptus, Maple, Oak, Aspen, Birch, Cottonwood, Alder, Ash, Cherry, Elm, Hickory, Poplar, Gum, Walnut, Locust, Sycamore, Beech, Catalpa, Sassafras, Gmelina, Albizia, Anthocephalus, and Magnolia. Nonlimiting examples of long fibers include fibers derived from Pine, Spruce, Fir, Tamarack, Hemlock, Cypress, and Cedar. Softwood fibers derived from the kraft process and originating from more-northern climates may be preferred. These are often referred to as northern softwood kraft (NSK) pulps.

Synthetic fibers may be selected from the group consisting of: wet spun fibers, dry spun fibers, melt spun (including melt blown) fibers, synthetic pulp fibers and mixtures thereof. Synthetic fibers may, for example, be comprised of cellulose (often referred to as “rayon”, and/or “lyocell”); cellulose derivatives such as esters, ether, or nitrous derivatives; polyolefins (including polyethylene and polypropylene); polyesters (including polyethylene terephthalate); polyamides (often referred to as “nylon”); acrylics; non-cellulosic polymeric carbohydrates (such as starch, chitin and chitin derivatives such as chitosan); and mixtures thereof.

The web (fibrous structure) of the present invention may comprise fibers, films and/or foams that comprises a hydroxyl polymer and optionally a crosslinking system. Nonlimiting examples of suitable hydroxyl polymers include polyols, such as polyvinyl alcohol, polyvinyl alcohol derivatives, polyvinyl alcohol copolymers, starch, starch derivatives, chitosan, chitosan derivatives, cellulose derivatives such as cellulose ether and ester derivatives, gums, arabinans, galactans, proteins and various other polysaccharides and mixtures thereof. For example, a web of the present invention may comprise a continuous or substantially continuous fiber comprising a starch hydroxyl polymer and a polyvinyl alcohol hydroxyl polymer produced by dry spinning and/or solvent spinning (both unlike wet spinning into a coagulating bath) a composition comprising the starch hydroxyl polymer and the polyvinyl alcohol hydroxyl polymer.

For purposes of the present invention, “fibrous structures” of the present invention may be in the form of wipes, especially wet wipes.

Suitable wipe substrates include nonwovens, films, foams, sponges, and the like. Preferred wipe substrates comprise a porous material which is capable of holding the composition within the pores of the substrate. Therefore, preferred substrates include nonwovens, foams, sponges and the like. For infant and incontinent adult wipe products, the substrate will preferably be a nonwoven. Nonwoven substrates used for the wipe product can be formed of cellulosic fibrous materials, synthetic polymeric fibrous materials, or a combination thereof (e.g., conform). For example, the nonwoven may contain from about 1% to 99% by weight cellulosic fiber and, respectively, from about 99% to 1% by weight synthetic polymeric fibers. Non-limiting examples of such materials include paper tissue, paper toweling, and nonwovens formed from rayon, polyolefins, polyester fibrous material or a combination of such materials with cellulosic fibers. The nonwovens may be air-laid, wet-laid, spun-laid, meltblown, or carded. The nonwoven may include one or more layers of fibrous material; e.g. a laminate of fibrous material. The separate layers may be formed of similar or dissimilar materials. The nonwoven may be treated, for example, to join the fibers of the nonwoven or to enhance the strength of the nonwoven. Such treatment may involve hydroentanglement, thermal bonding, or treatment with a binder.

Cellulosic nonwovens, particularly nonwovens wherein the fibrous material consists essentially of cellulosic products, are economically and environmentally preferred. Cellulosic nonwovens that are especially suitable for use in the present invention are described in U.S. Pat. No. 3,905,863 issued to Ayers on Sep. 16, 1975; U.S. Pat. No. 3,974,025 issued to Ayers on Aug. 10, 1976; and U.S. Pat. No. 4,191,609 issued to Trokhan on Mar. 4, 1980. Each of these references are incorporated herein by reference in their entirety.

The wipes may be formed by any suitable process known in the art such as hydroentangling, air-laid, wet-laid, co-forming processes.

Techniques for combining wipe substrates with a cleansing or treating composition, and for their packaging are well known in the art and are applicable to the present invention. In general, the wipe substrate is combined with the composition by one or more techniques involving coating, immersing, dipping, spraying, extruding, and the like. In general, the wipes are combined with an amount of the composition sufficient to provide good effective cleansing. It is often important to employ a loading that provides an acceptable tactile impression (e.g., sufficient but not excessive wetness, not excessively greasy or oily). Thus, the wipe substrates are typically combined with the composition in an amount of from about 2 to about 8 times, preferably about 3 to about 5 times the dry weight of the substrate. For example, a suitable incontinent adult wipe for use in cleansing the perineal area, which contains a cellulosic nonwoven, may contain the composition in an amount of about 3 times the dry weight of the nonwoven.

The fibrous structures and/or wipes of the present invention may comprise any suitable additives known to those of ordinary skill in the art. Nonlimiting examples of such additives include softeners, lotions, permanent and/or temporary wet strength agents, and wet wipe additives, examples of which are described in U.S. Pat. No. 5,648,083.

“Fibrous structure” as used herein means a structure that comprises one or more fibers. Nonlimiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous suspension is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

“Sanitary tissue product” comprises one or more finished fibrous structures, converted or not, that is useful as a wiping implement for post-urinary and post-bowel movement cleaning (toilet tissue), for otorhinolaryngological discharges (facial tissue), and multi-functional absorbent and cleaning uses (absorbent towels).

Container System

a. Container

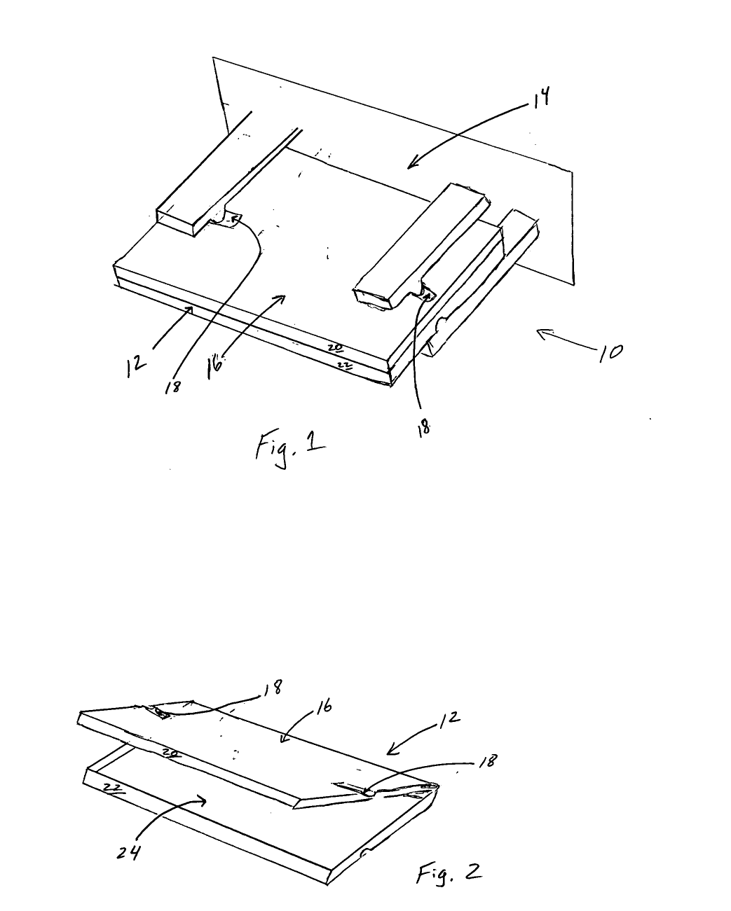

As shown in FIGS. 1 and 2, a container system 10 comprises a container 12 and a holder 14. The container 12 comprises a body 16. The body 16 may enclose and define an internal volume capable of storing articles to be dispensed. The body 16 comprises an attachment element 18. The attachment element 18 may comprise a deformation of the body 16. The attachment element 18 may be affixed, permanently and/or releasably to the body 16. The attachment element 18 may comprise an indentation, such as a groove (shown), a protrusion, and mixtures thereof.

The container 12 may comprise two members 20 and 22. The two members 20 and 22 may be hingedly attached to each other, directly and/or indirectly, permanently and/or releasably, such that movement of one of the two members relative to the other opens or closes the container 12. Upon opening the container 12, a user gains access to the internal volume 24 of the container 12 as shown in FIG. 2. The internal volume 24 may be capable of storing articles to be dispensed. In one example, the internal volume 24 stores fibrous structures, such as wipes. In another example, the internal volume 24 may store a package of fibrous structures, such as a package of wipes. In yet another example, the internal volume 24 may store a resealable package of fibrous structures, such as a resealable package of wipes. In such an example, the first and/or second member 20, 22 may comprise an opening 25 through which the resealable portion of the resealable package of fibrous structures is accessible without opening the container 12, as shown in FIG. 10. Such a container as shown in FIG. 10 can also be attached to different types of holders of the present invention. By using a container 12, as shown in FIG. 10 for example, the container 12 needs only be opened to replace the resealable package of fibrous structures once the package is emptied over multiple uses. As a result, the holder would not be required to be movable to permit the opening of the container. In other words, the holder may have arms or other holding elements that are stationary and are capable of receiving the container. The fibrous structures may be in discrete sheet form. The discrete sheets may be arranged in an interlocking Z-fold and/or C-fold and/or in a non-interlocking configuration.

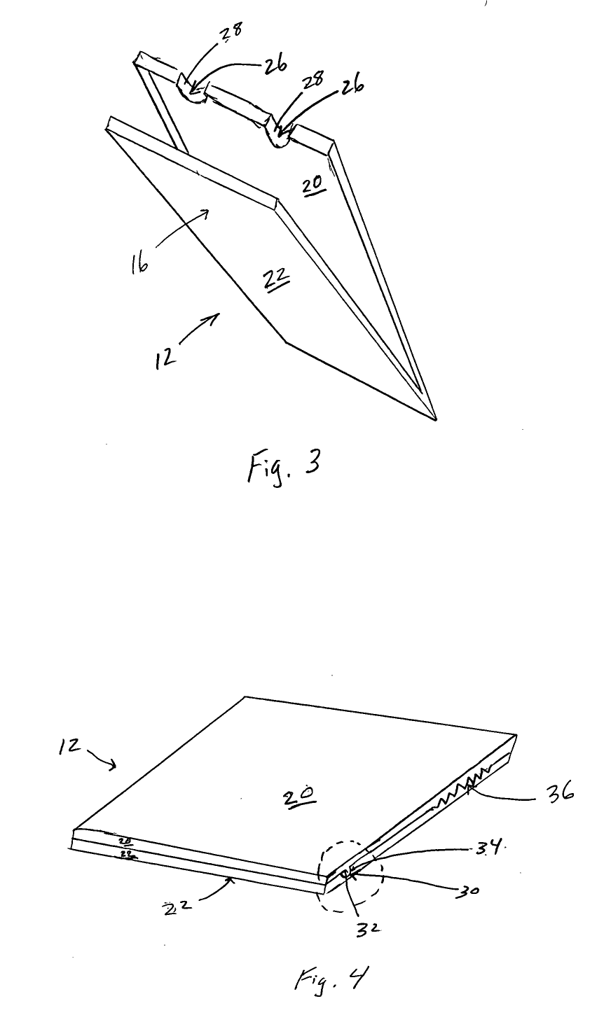

As shown in FIG. 3, the container 12 may comprise an opening element 26. The opening element 26 may be a deformation in the body 16 of the container 12. The deformation may be present in the first member 20 of the body 16, such as an opening 28 in the first member 20 that provides access to the second member 22 of the body 16 when the container 12 is in a closed state.

As shown in FIG. 4, the container 12 may comprise a closing element 30. The closing element 30 may be a deformation in the body 16 of the container 12. The deformation may be present in the first member 20 and/or in the second member 22. When the deformation is present in the first and second members 20, 22 the deformations may be complementary. In one example, the deformation in the first member 20 may be a protusion 32 and the deformation in the second member 22 may be an indentation 34 capable of receiving the protusion 32 of the first member 20.

As shown in FIG. 4, the closing element 30 may be present on the outer peripheries of the first and second members 20, 22.

The closing element 30 inhibits movement of the first and second members 20, 22 relative to each other, especially when the container 12 is in its closed state. A sufficient amount of force is needed to cause the container 12 to open. Such a force can be exerted by a user during use of the container 12.

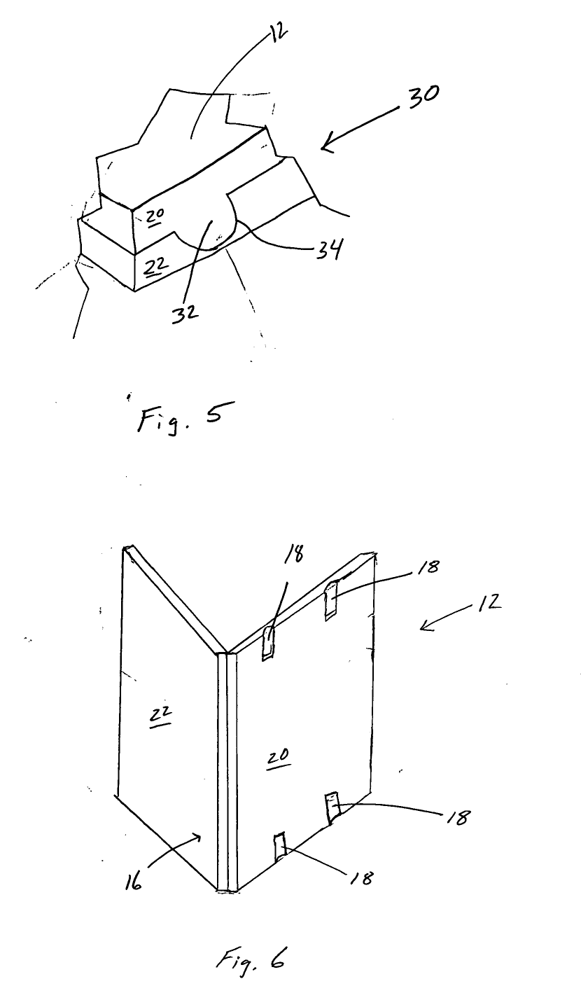

In one example, the closing element 30 may comprise complementary gripping teeth 36 as shown in FIG. 5. The gripping teeth 36 may help to hold the first and second members 20, 22 from moving relative to one another. In addition, the gripping teeth 36 may also hold a package of fibrous structures in place within the internal volume 24 of the container 12. Those of skill in the art will appreciate that alternative structures other than gripping teeth 24 may be used so long as the other structures perform at least a similar function as the gripping teeth 24.

The closing elements 30 may be on one, two or more peripheral edges of the first and/or second members 20, 22 of the container 12.

FIG. 5 illustrates an enlarged view of the closing element 30 from FIG. 4. The container 12 comprises the closing element 30 which comprises a protrusion 32 protruding from the periphery of the first member 20 and an indentation 34 formed in the second member 22.

As shown in FIG. 6, a container 12 in accordance with the present invention may comprise a first member 20 that comprises attachment elements 18 and a second member 22 that is void of any attachment elements 18.

b. Holder

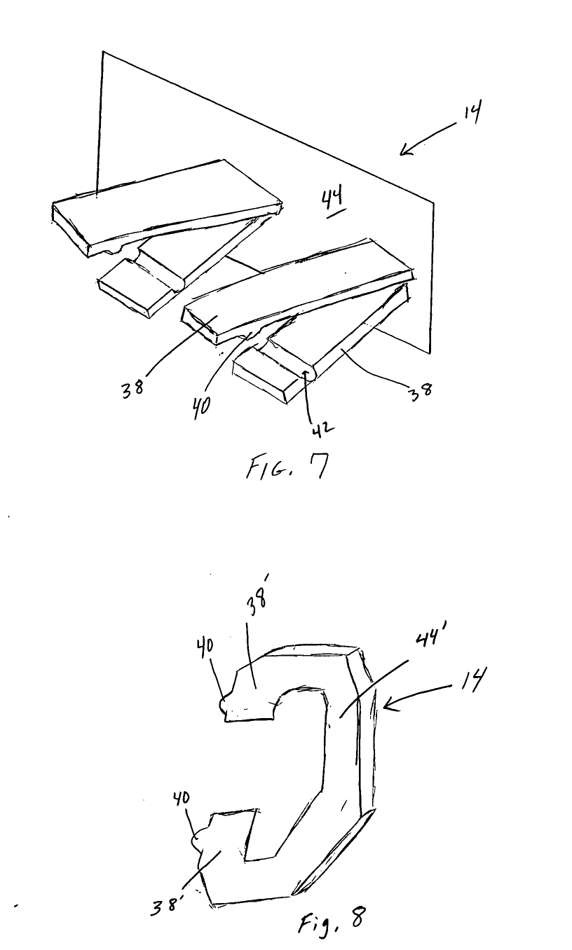

As shown in FIG. 7, the holder 14 may comprise an arm 38 that comprises a deformation capable of contacting a container 12 to hold the container 12 in place. The deformation on the arm 38 may be a protrusion 40, an indentation 42 and mixtures thereof.

The holder 14 may comprise one or more arms 38. In one example, the holder 14 comprises two arms 38. In another example, the holder 14 comprises four arms 38.

The arms 38 may be affixed, directly and/or indirectly, permanently and/or releasably, to a support 44. The support 44 is capable of being affixed, directly and/or indirectly, permanently and/or releasably, an external object, such as a wall, more particularly such as a wall within a user's domicile, even more particularly a wall within a user's bathroom.

In use, a container (not shown) can brought into contact with a deformation of an arm 38 of a holder 14. In one example, the container (not shown) may comprise a complementary deformation such that the container's deformation and the deformation of the arm 38 of the holder 14 are in contact with one another.

FIG. 8 illustrates an example of another holder 14 in accordance with the present invention. The holder 14 comprises a combined support 44′ and arm 38′. The arm 38′ comprises a deformation, such as a protrusion 40. This type of holder 14 may be utilized with a container as shown in FIG. 6 wherein the container comprises a first member that comprises attaching elements and a second member that is void of attaching elements. When using such a container with the holder 14 shown in FIG. 8 the deformations on the arms 38′ of the holder 14 will contact the attachment elements of the container.

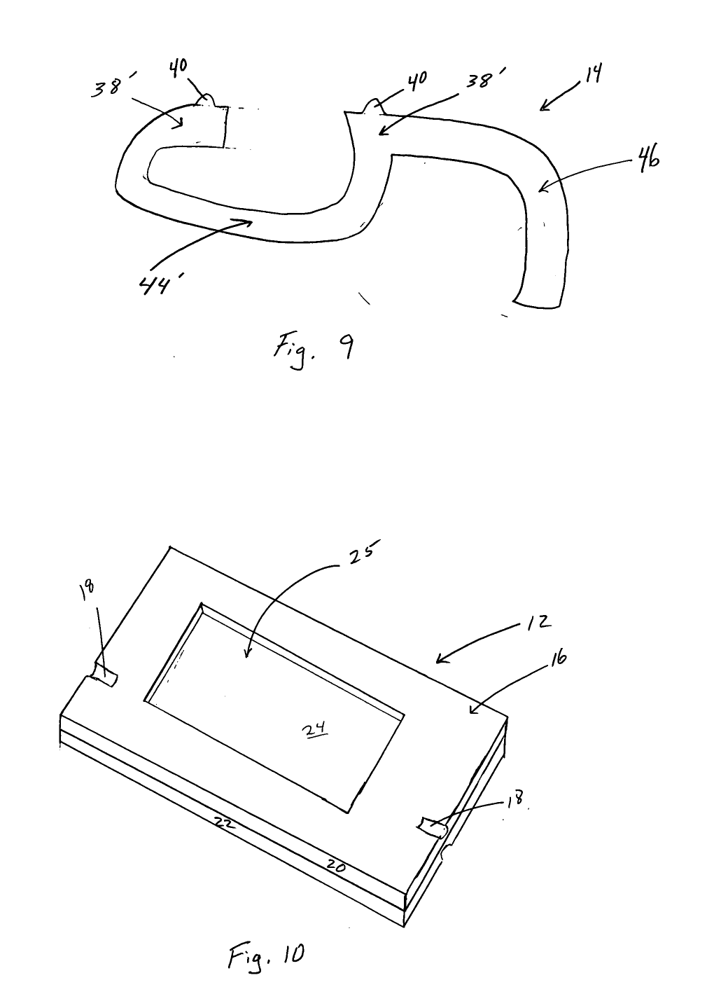

As shown in FIG. 9, a holder 14 may comprise, in addition to the arm(s) 38′ and the support 44′, a clamping element 46 capable of releasably clamping the holder 14 to an external object, for example such as a toilet, especially a toilet bowl. Such a holder 14 can be used with a container in accordance with the present invention, for example as shown in FIG. 6.

The deformations on the container and the holder may be formed into the container and/or holder upon formation.

The deformations on the container and the holder may be a separate component from the container and/or holder that is permanently or releasably attached to the container and/or holder.

The container and holder may, independently, be made from any suitable material known in the art, such as plastic, metal, ceramic, wood, paper, cardboard, and the like.

Article of Manufacture

A container comprising an article, such as a fibrous structure and a holder may be packaged together within the same packaging film or separate packaging films so long as the container and holder are next to each other at a point of sale.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A container having a body and an interior volume capable of storing articles to be dispensed, the body comprising an attachment element capable of attaching the container to a holder for the container.

2. The container according to claim 1 wherein the attachment element comprises a deformation on the body.

3. The container according to claim 2 wherein the deformation is selected from the group consisting of: indentations, protrusions and mixtures thereof.

4. The container according to claim 1 wherein the attachment element is affixed to the body.

5. The container according to claim 1 wherein the container comprises two members that are hingedly attached to each other such that movement of the two members relative to the each other opens or closes the container.

6. The container according to claim 5 wherein one of the two members comprises an opening element that facilitates movement of the two members relative to each other.

7. The container according to claim 5 wherein at least one of the two members comprises a closing element that inhibits movement of the two members relative to each other.

8. The container according to claim 7 wherein the two members comprise complementary closing elements that inhibit movement of the two members relative to each other when the container is in a closed state.

9. The container according to claim 8 wherein the complementary closing elements comprises protusions and indentations that receive such protrusions.

10. The container according to claim 8 wherein the complementary closing elements are present on an edge of each of the two members.

11. The container according to claim 8 wherein the complementary closing elements comprise gripping teeth.

12. A container product comprising a container according to claim 1 wherein the articles comprise a fibrous structure.

13. The container product according to claim 12 wherein the fibrous structure comprises a wet wipe.

14. A container system comprising:
a. a container having a body and an interior volume capable of storing articles to be dispensed, the body comprising an attachment element capable of attaching the container to a holder for the container; and
b. a holder for the container capable of receiving the attachment element of the body.

15. The container system according to claim 12 wherein the holder is permanently fixed to an external object.

16. The container system according to claim 13 wherein the external object is a wall in a domicile.

17. The container system according to claim 12 wherein the holder is releasably fixed to an external object.

18. The container system according to claim 15 wherein the external object is a toilet.

19. The container system according to claim 12 wherein the container houses a fibrous structure.

20. The container system according to claim 17 wherein the fibrous structure comprises a wet wipe.

21. A kit comprising:
a. a container comprising a surface having an attachment element capable of attaching the container to a holder for the container; and
b. a holder for the container.

22. The kit according to claim 19 wherein the container houses a fibrous structure.

23. The kit according to claim 20 wherein the fibrous structure comprises a wet wipe.
